(19) United States
(12) Patent Application Publication
(10) Pub. No.: US 2003/0164908 A1
(43) Pub. Date: Sep. 4, 2003

(54) Thin film transistor panel

(75) Inventor: Cheng Chi Wang, Tainan Science-based Industrial Park (TW)

Correspondence Address: LOWE HAUPTMAN GILMAN & BERNER, LLP, Suite 310, 1700 Diagonal Road, Alexandria, VA, 22314, US

(73) Assignee: CHI MEI OPTOELECTRONICS CORP.

(21) Appl. No.: 10/084,989

(22) Filed: Mar. 1, 2002

(51) Int. Cl. G02F 1/136

(52) U.S. Cl. 349/113

(57) ABSTRACT

A thin film transistor panel includes a gate line with a gate electrode on a substrate, a gate insulating layer on the gate line, a semiconductor layer on the gate insulating layer, a conductive pattern layer with source and drain electrodes spaced apart on the semiconductor layer, a passivation layer on the semiconductor layer and the conductive pattern layer, and a plurality of pixel electrodes on the passivation layer. The thin film transistor panel is characterized in that the conductive pattern layer is formed from composite metallic layers including Mo/Ag—Al alloy/Mo. Furthermore, the gate line may be formed from a gate metal layer including an Ag—Al alloy layer and a molybdenum layer. The present invention further provides a sputtering target of Ag—Al alloy for forming the Ag—Al alloy layer.

### BACKGROUND OF THE INVENTION

1. Field of the Invention

The present invention relates to a thin film transistor panel employed in a flat display.

2. Description of the Related Art

In order to minimize the space required by display devices, researches have been undertaken into the development of various flat panel display devices such as liquid crystal display (LCD) devices, plasma display panels (PDP) and electro-luminescence displays (EL). Particularly, in the case of LCD devices, liquid crystal technology has been explored because the optical characteristics of liquid crystal material can be controlled in response to changes in electric fields applied thereto.

At present, the dominant methods for fabricating LCD devices are based on amorphous silicon (a-Si) thin film transistor (TFT) technologies. Using these technologies, high quality image displays of substantial size can be fabricated by using low temperature processes. As will be understood by those skilled in the art, conventional LCD devices typically include a TFT panel, a color filter panel and a liquid crystal layer interposed therebetween.

FIG. 1 is a flowchart illustrating the steps of a conventional method of forming a TFT panel, and FIGS. 2a-2e are sectional views illustrating a portion of a TFT panel manufactured by the conventional method of FIG. 1.

A conventional method for manufacturing a TFT panel will now be described with reference to FIGS. 1 and 2a-2e. First, a first metal layer, having a stacked structure including chromium (Cr) and an aluminum (Al) alloy, is sputtered on a transparent glass substrate 200 to a predetermined thickness (step 101). In FIG. 2a, the first metal layer is etched by a first photolithography process to form a gate electrode 202 and a gate line (not shown) on the substrate 200 (step 102). Then, an insulating layer (e.g., SiNₓ layer) is deposited on the entire surface of the substrate having the gate electrode 202 and the gate line (not shown) thereon to form a gate insulating layer 204. An amorphous silicon layer 206 and an impurity-doped amorphous silicon layer 208 (e.g., n+ amorphous silicon layer), are then sequentially deposited on the gate insulating layer 204 to form an amorphous semiconductor layer 210 (step 103). Next, as shown in FIG. 2b, the amorphous semiconductor layer 210 is patterned by a second photolithography process with a photoresist pattern 211, resulting in a semiconductor pattern 212 on the TFT portion of the substrate 200 (step 104).

Then, a second metal layer (source/drain (S/D) metal layer) such as Cr is sputtered on the entire surface of the insulation layer 204 and on the amorphous semiconductor pattern 212 to a predetermined thickness (step 105). As shown in FIG. 2c, the second metal layer is then patterned by a third photolithography process using a photoresist pattern 220 to form a data line (not shown), a source electrode 216 and a drain electrode 214 on the TFT portion of the substrate, wherein the source electrode 216 and the drain electrode 214 are separated by a channel region 218 (step 106).

In FIG. 2d, the impurity-doped amorphous silicon layer 208 at the channel region 218 is etched by using the source and drain electrodes 216 and 214 as an etch-protect mask (step 107). Then, as shown in FIG. 2e, the photoresist pattern 220 is removed.

A passivation layer (not shown, e.g., SiNₓ layer) is then formed on the entire surface of the above structure to a predetermined thickness (step 108). The passivation layer is then patterned to expose parts of the drain electrode 214 using a fourth photolithography process (step 109). After forming an indium-tin-oxide (ITO) layer as a transparent conductive layer on the passivation layer pattern (step 110), the ITO layer is patterned by a fifth photolithography process (step 111).

However, the use of chromium (Cr) as the second metal layer may not be preferred for a data line material because of its relative high resistance. This relative high resistance may lead to RC delay associated with the data line as well as reduce the image quality. The use of chromium as the second metal layer may also be constrained by the frequent discontinuity in the metal line during processing thereby reducing yield rate. Also, the use of aluminum (Al) or an alloy thereof may not be preferred because the contact formation of aluminum based alloys and indium-tin-oxide (ITO) layers will result in aluminum oxide clusters. These oxide clusters typically act as electrical insulators to increase contact resistance. As will be understood by those skilled in the art, these insulating clusters are generated when the current passes through the aluminum/ITO contacts and causes aluminum atoms to migrate into the ITO. This parasitic phenomenon is typically referred to as “metal migration”.

The present invention therefore seeks to provide an improved S/D metal layer for manufacturing a TFT panel that overcomes, or at least reduces the above-mentioned problems of the prior art.

### SUMMARY OF THE INVENTION

It is therefore an object of the present invention to provide an improved S/D metal layer for manufacturing a thin film transistor panel which is less susceptible to parasitic metal migration.

It is another object of the present invention to provide liquid crystal displays having improved pixel electrodes.

The above listed and other objects of the present invention are achieved by providing composite metallic layers including Mo/Ag—Al alloy/Mo as the S/D metal layer to provide low resistance contacts and paths for electrical signals and are less susceptible to parasitic metal migration.

In a general aspect of the present invention, the thin film transistor panel comprises a gate line with a gate electrode on a substrate, a gate insulating layer on the gate line, a semiconductor layer on the gate insulating layer, a conductive pattern layer with source and drain electrodes spaced apart on the semiconductor layer, a passivation layer on the semiconductor layer and the conductive pattern layer, and a plurality of pixel electrodes on the passivation layer.

According to one embodiment of the present invention, the conductive pattern layer is formed from composite metallic layers including Mo/Ag—Al alloy/Mo.

According to another embodiment of the present invention, the gate line comprises an Ag—Al alloy layer on the substrate and a molybdenum layer on the Ag—Al alloy layer.

The present invention further provides a liquid crystal display including a top plate provided with a transparent electrode, a bottom plate provided with reflective electrodes of Ag—Al alloy, and a liquid crystal layer sandwiched between the top plate and the bottom plate. In this embodiment, an image is generated by the reflective liquid crystal display when ambient light is incident to the surface of the top plate.

In still another embodiment of the present invention, the Ag—Al alloy is utilized to create a transflective LCD. By providing the pixel electrodes of the Ag—Al alloy with apertures, sufficient light from a light source (backlight) is passed. Accordingly, in this embodiment, an image is generated by the transflective LCD when either ambient light is incident to the surface of the pixel electrodes or when light from the light source passes through the apertures.

According to the present invention, the Ag—Al alloy contains about 1 to about 50 at % of silver, preferably contains about 5 to about 10 at % of silver, and most preferably contains about 10 at % of silver.

### BRIEF DESCRIPTION OF THE DRAWINGS

Other objects, advantages, and novel features of the invention will become more apparent from the following detailed description when taken in conjunction with the accompanying drawings.

FIG. 1 is a flowchart illustrating a conventional method for manufacturing a thin-film transistor (TFT) panel;

FIGS. 2a-2e illustrate, in cross-sectional view, the major steps of fabrication of a TFT panel according to the method of FIG. 1;

FIG. 3 is a cross sectional view of a portion of a LCD according to an embodiment of the present invention;

FIG. 4 is a top plan view of a bottom plate of the LCD shown in FIG. 3 according to the present invention;

FIG. 5 is a cross sectional view of a portion of the bottom plate shown in FIG. 3; and

FIG. 6 is a top plan view of a bottom plate of a transflective LCD according to another embodiment of the present invention.

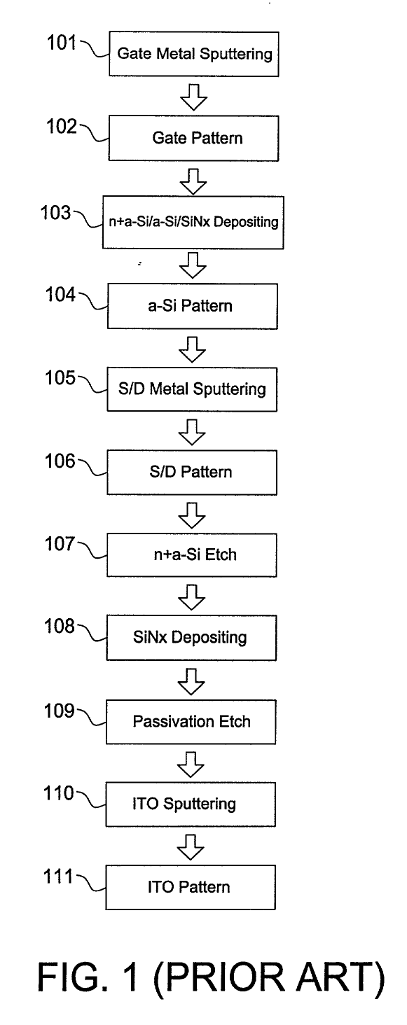

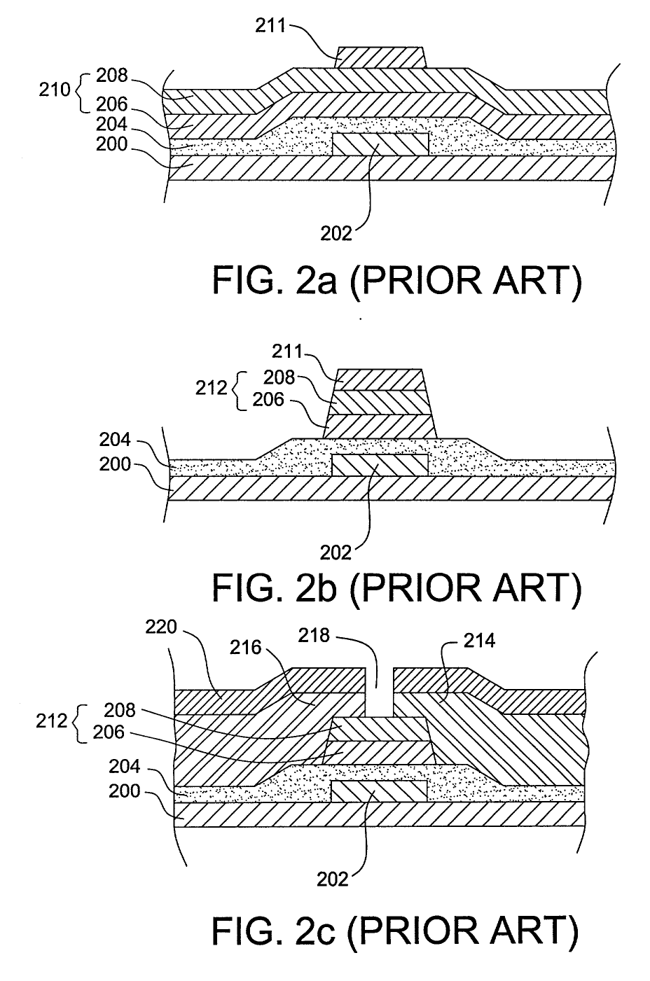

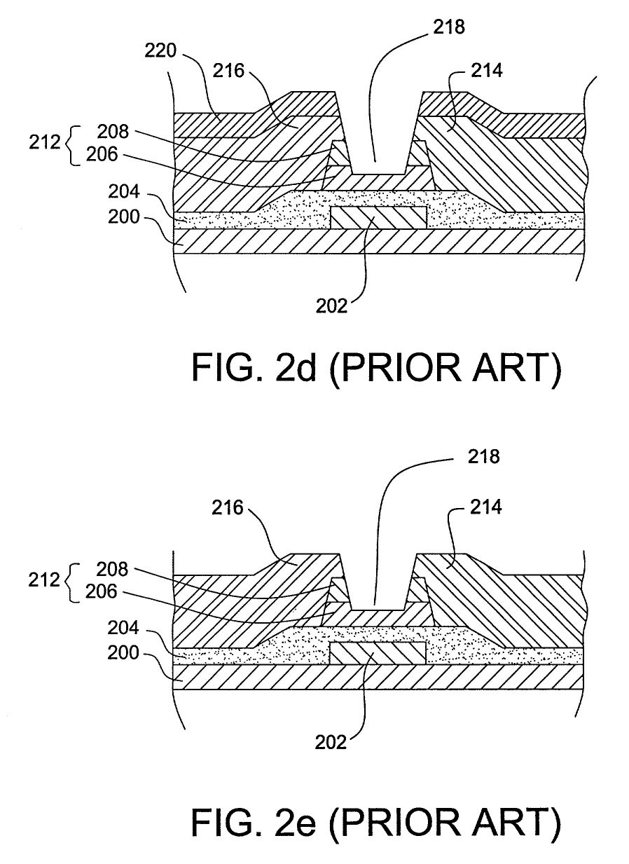

### DETAILED DESCRIPTION OF THE PREFERRED EMBODIMENT

As to the problem occurred in conventional LCD devices as described above, the inventor has found during researches that composite metallic layers including Mo/Ag—Al alloy/Mo can replace chromium as the S/D metal layer.

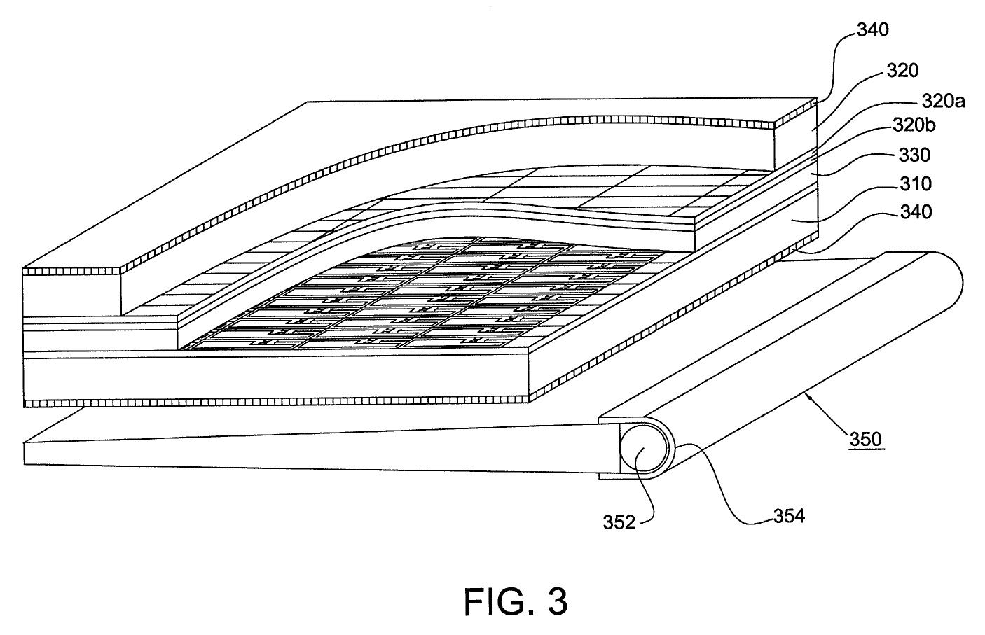

As aforementioned, numerous devices can be formed utilizing thin film transistors (TFT's), one particular utilization is in active matrix liquid crystal displays (AMLCD's) and the composite metallic layers of the present invention will be described as a portion of an AMLCD. FIG. 3 shows a schematic representation of an AMLCD according to one embodiment of the present invention. The AMLCD mainly comprises a liquid crystal panel including a bottom plate 310, a top plate 320 bonded to the bottom plate 310 and a liquid crystal 330 filled between the top and bottom plates. Typically, the bottom plate 310 is provided with a plurality of pixels arranged as a matrix, and the top plate 320 is provided with a color filter 320a for displaying colors and a transparent electrode 320b such as an ITO electrode as a common electrode. Polarizing plates 340, which polarize visible light, are respectively attached to the surfaces of the top and bottom plates. A light source such as a backlight module 350 is provided behind the polarizer 340 on the bottom plate 310. The backlight module 350 typically includes a lamp such as a fluorescent tube 352 contained within a tubular housing 354 that has an inner mirrored surface. Light generated from the fluorescent tube 352 enters the backlight module 350, and is reflected into the liquid crystal layer. Typically, the top plate 320 is referred to as a color filter (CF) substrate because color filters are formed, while the bottom plate 310 is referred to as a TFT substrate.

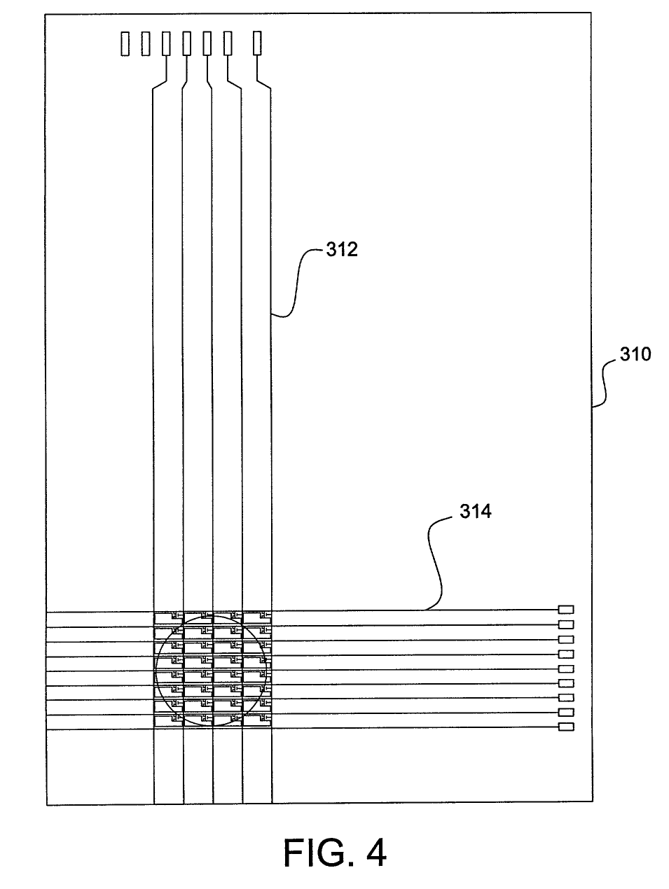

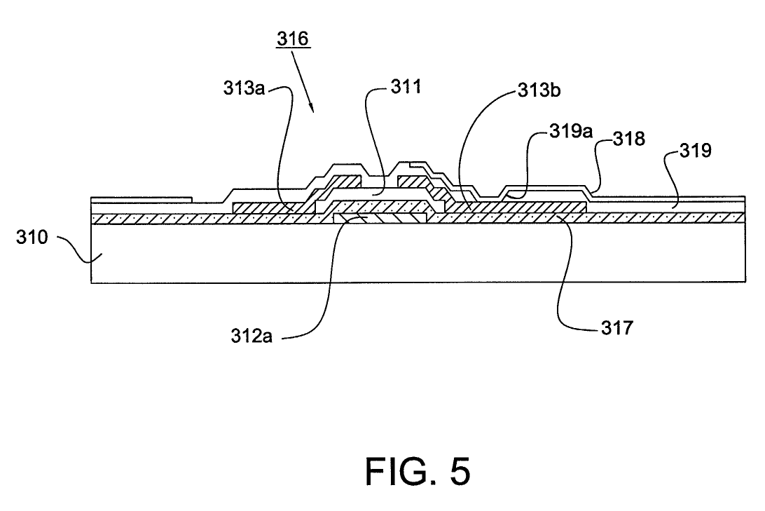

FIG. 4 is a top plan view of the bottom plate 310 of the LCD shown in FIG. 3. On the central region of the bottom plate 310, there are formed a plurality of parallel gate lines 312 and a plurality of parallel data lines 314 perpendicular to the gate lines 312. The pixel region described above is a region where is surrounded by two adjacent gate lines 312 and two adjacent data lines 314. These gate lines 312 and data lines 314 are insulated from each other through a gate insulating layer 317 (see FIG. 5). Specifically, in each pixel region, as shown in FIG. 5, there are formed a thin film transistor (TFT) 316 as a switching element, a pixel electrode 318 and a passivation layer 319 formed between the TFT and the pixel electrode. The passivation layer 319 has a plurality of contact holes 319a. The TFT comprises a gate electrode 312a, a semiconductor layer 311 and source/drain electrodes 313a, 313b. When a scanning signal is fed to a gate line, the thin film transistor is turned on to feed the data signal therethrough to the pixel electrode.

According to one embodiment of the present invention, the data lines 314 and the source/drain electrodes 313a, 313b are formed from composite metallic layers including Mo/Ag—Al alloy/Mo. Specifically, the composite metallic layers of the present invention are formed by depositing a first barrier layer of molybdenum to a thickness of about 150 to about 700 Angstroms. A second conductivity enhancing layer of Ag—Al alloy then is deposited to a thickness of about 1000 to about 3000 Angstroms. According to the present invention, the second conductivity enhancing layer is preferably deposited by sputtering using a sputtering target of Ag—Al alloy. A third barrier layer of molybdenum then is deposited to a thickness of about 300 to about 1000 Angstroms. The composite metallic layers of the present invention are utilized as the S/D metal layer to provide low resistance contacts and paths for electrical signals and are less susceptible to parasitic metal migration which can limit display quality and lifetime. According to the present invention, formation of the data lines 314 and the source/drain electrodes 313a, 313b is accomplished by: 1) depositing the composite metallic layers, 2) applying photo resist, 3) soft baking the photo resist, 4) exposing a pattern onto the photo resist, 5) developing the exposed or unexposed photo resist, 6) hard baking the photo resist prior to etching, 7) dry or wet etching the composite metallic layers and 8) stripping the photo resist.

The etching process of step 7 etches through both the molybdenum layer and the Ag—Al alloy layer to reach the gate insulating layer. If the etching rate of the molybdenum layer is slower or faster than the etching rate of the Ag—Al alloy layer, then a step coverage problem is created for both the passivation layer 319 and the pixel electrode 318. The passivation layer 319 may fail to completely cover the S/D metal, i.e., the composite metallic layers of the present invention, and hence the S/D metal is short to the pixel electrode 318. In view of the problems, the content of silver in the Ag—Al alloy layer is adjusted so that the etching rate of the Ag—Al alloy layer is substantially compatible with the etching rate of the molybdenum layer to result in the S/D metal layer having a taper profile. Preferably, the Ag—Al alloy of the present invention contains about 1 to about 50 at % of silver, more preferably contains about 5 to about 10 at % of silver, and most preferably contains about 10 at % of silver when the composite metallic layers are etched using a solution of H₃PO₄, CH₃COOH, HNO₃, and H₂O.

According to another embodiment of the present invention, the gate lines 312 and the gate electrodes 312a are formed from a gate metal layer including an Ag—Al alloy layer and a molybdenum layer. Specifically, the gate metal layer of the present invention are formed by depositing a barrier layer of molybdenum to a thickness of about 150 to about 700 Angstroms and a conductivity enhancing layer of Ag—Al alloy to a thickness of about 1000 to about 5000 Angstroms. According to the present invention, the conductivity enhancing layer is preferably deposited by sputtering using a sputtering target of Ag—Al alloy. Preferably, the sputtering target of Ag—Al alloy contains about 1 to about 50 at % of silver, more preferably contains about 5 to about 10 at % of silver, and most preferably contains about 10 at % of silver.

Furthermore, the inventor has found during researches that the Ag—Al alloy of the present invention have a high reflectance and can be used to replace commercially available materials such as ACA (Ag—Cu—Au alloy, Kobelco Inc.) or APC (Ag—Pd—Cu alloy, Furuya metal Inc.) as the reflective electrodes in LCDs of the reflective type. The inventor has investigated the visible light reflectance of Ag—Al alloy (10% of silver), and the result shows that the visible light reflectance of Ag—Al alloy (10% of silver) is about 95% close to the visible light reflectance of ACA (about 98%) and APC(about 96%). In addition, if the Ag—Al alloy of the present invention is fabricated by physical vapor deposition and annealed at temperatures from 200° C. to 250° C., the visible light reflectance of annealed Ag—Al alloy (10% of silver) becomes about 97%. Therefore, in another preferred embodiment of the present invention, the Ag—Al alloy is utilized to form the pixel electrodes 318 shown in FIG. 5 to create a reflective LCD.

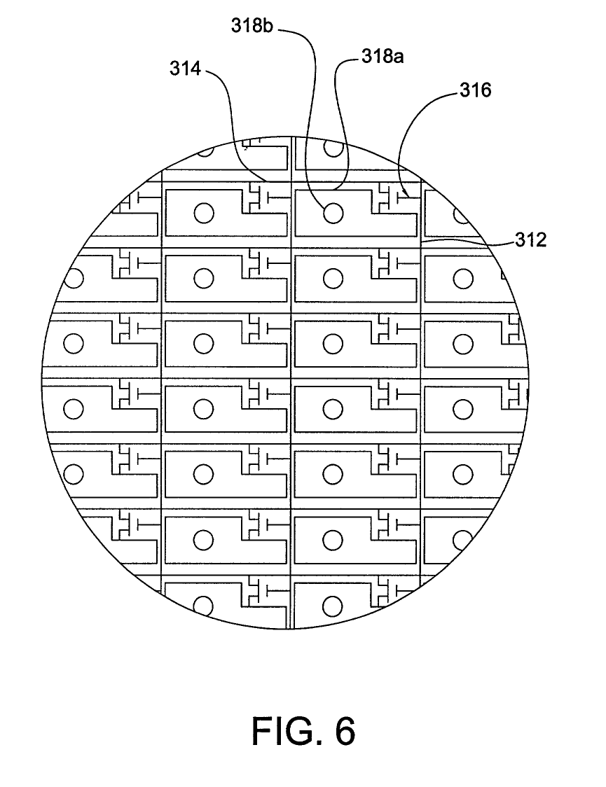

In still another embodiment of the present invention, the Ag—Al alloy is utilized to form the pixel electrodes 318a shown in FIG. 6 to create a transflective LCD. As shown in FIG. 6, by providing the pixel electrodes 318a with apertures 318b (occupying for example up to 30% of the surface area), sufficient light from a light source (backlight) is passed. On the other hand, the layer of reflective material, i.e., the Ag—Al alloy of the present invention can reflect incident ambient light. Accordingly, an image is generated by the transflective LCD of the present invention when either ambient light is incident to the surface of the pixel electrodes 318a or when the light from the light source passes through the apertures 318b.

Although the invention has been explained in relation to its preferred embodiment, it is to be understood that many other possible modifications and variations can be made without departing from the spirit and scope of the invention as hereinafter claimed.

What is claimed is:

1. A thin film transistor panel comprising:
a gate line with a gate electrode on a substrate;
a gate insulating layer on the gate line;
a semiconductor layer on the gate insulating layer;
a conductive pattern layer with source and drain electrodes spaced apart on the semiconductor layer, the conductive pattern layer comprising a first molybdenum layer, an Ag—Al alloy layer on the first molybdenum layer and a second molybdenum layer on the Ag—Al alloy layer;
a passivation layer on the semiconductor layer and the conductive pattern layer, the passivation layer having a plurality of contact holes; and
a plurality of pixel electrodes on the passivation layer, each of the pixel electrodes extending into one of the contact holes to contact the molybdenum layer.

2. The thin film transistor panel as claimed in claim 1, wherein the gate line comprises an Ag—Al alloy layer on the substrate and a molybdenum layer on the Ag—Al alloy layer.

3. The thin film transistor panel as claimed in claim 1, wherein the Ag—Al alloy layer contains about 1 to about 50 at % of silver.

4. The thin film transistor panel as claimed in claim 1, wherein the Ag—Al alloy layer contains about 5 to about 10 at % of silver.

5. The thin film transistor panel as claimed in claim 1, wherein the Ag—Al alloy layer contains about 10 at % of silver.

6. A liquid crystal display, comprising:
a top plate comprising a transparent electrode;
a bottom plate comprising reflective electrodes of Ag—Al alloy; and
a liquid crystal layer sandwiched between the top plate and the bottom plate,
wherein an image is generated by the liquid crystal display when ambient light is incident to the surface of the top plate.

7. The liquid crystal display as claimed in claim 6, further comprising a light source behind the bottom plate wherein each of the reflective electrodes has at least one aperture defined therein such that an image is generated by the liquid crystal display when light from the light source passes through the apertures of the reflective electrodes.

8. The liquid crystal display as claimed in claim 7, wherein the bottom plate further comprises:
a plurality of parallel gate lines;
a plurality of parallel data lines formed perpendicular to the gate lines, the gate lines and the data lines being arranged to form a matrix of pixel regions with each of the pixel regions bounded by two adjacent gate lines and two adjacent data lines; and
a plurality of thin film transistors formed at intersections between the gate lines and data lines,
wherein each of the reflective electrodes is respectively disposed in one of the pixel regions and functions as a pixel electrode.

9. The liquid crystal display as claimed in claim 6, wherein the Ag—Al alloy contains about 1 to about 50 at % of silver.

10. The liquid crystal display as claimed in claim 6, wherein the Ag—Al alloy contains about 5 to about 10 at % of silver.

11. The liquid crystal display as claimed in claim 6, wherein the reflective electrodes are formed from an annealed thin film of Ag—Al alloy.

12. The liquid crystal display as claimed in claim 11, wherein the reflective electrodes have a visible light reflectance greater than 95%.

13. A sputtering target for forming a metal film, the sputtering target comprises an Ag—Al alloy.

14. The sputtering target as claimed in claim 13, wherein the Ag—Al alloy contains about 1 to about 50 at % of silver.

15. The sputtering target as claimed in claim 13, wherein the Ag—Al alloy contains about 5 to about 10 at % of silver.

16. The sputtering target as claimed in claim 13, wherein the Ag—Al alloy contains about 10 at % of silver.

17. A thin film transistor panel comprising:
a gate line with a gate electrode on a substrate, the gate line comprising an Ag—Al alloy layer on the substrate and a molybdenum layer on the Ag—Al alloy layer;
a gate insulating layer on the gate line;
a semiconductor layer on the gate insulating layer;
a conductive pattern layer with spaced apart source and drain electrodes on the semiconductor layer;
a passivation layer on the semiconductor layer and the conductive pattern layer, the passivation layer having a plurality of contact holes; and
a plurality of pixel electrodes on the passivation layer, each of the pixel electrodes extending into one of the contact holes and directly contacting the molybdenum layer.

18. The thin film transistor panel as claimed in claim 17, wherein the conductive pattern layer comprising a first molybdenum layer, an Ag—Al alloy layer on the first molybdenum layer and a second molybdenum layer on the Ag—Al alloy layer.

19. The thin film transistor panel as claimed in claim 17, wherein the Ag—Al alloy layer contains about 1 to about 50 at % of silver.

20. The thin film transistor panel as claimed in claim 17, wherein the Ag—Al alloy layer contains about 5 to about 10 at % of silver.
